(19) United States
(12) Patent Application Publication
(10) Pub. No.: US 2016/0173645 A1
(43) Pub. Date: Jun. 16, 2016

(54) IMAGE PROCESSING APPARATUS AND CONTROL METHOD THEREOF, AND SYSTEM

(71) Applicant: CANON KABUSHIKI KAISHA, Tokyo (JP)

(72) Inventor: Ryusuke Okuhara, Yokohama-shi (JP)

(21) Appl. No.: 14/963,820

(22) Filed: Dec. 9, 2015

(30) Foreign Application Priority Data
Dec. 11, 2014 (JP) 2014-251074

(51) Int. Cl. H04L 29/08; G06F 3/0484; G06F 3/0482; H04N 5/44

(52) U.S. Cl. CPC H04L 67/327; H04L 67/06; H04N 5/44; G06F 3/04842; G06F 3/0482

(57) ABSTRACT

An image processing apparatus comprises a connection unit configured to connect to at least one network service, an acquisition unit configured to acquire information regarding the at least one network service that is connectable via the connection unit, a determination unit configured to, in a case where connection to a predetermined network service is instructed by a user, determine whether or not a file that is supported by the predetermined network service is recorded in a recoding medium of the image processing apparatus based on the information regarding the predetermined network service acquired by the acquisition unit, and a control unit configured to perform control such that connection to the predetermined network service is not performed in a case where no file that is supported by the predetermined network service is recorded in the recording medium.

### BACKGROUND OF THE INVENTION

1. Field of the Invention

The present invention relates to processing for connecting to a network performed by an apparatus provided with a communication function.

2. Description of the Related Art

In recent years, digital cameras with a built-in wireless communication function, and recording media equipped with a wireless communication function have appeared. With the use of this wireless communication function, it becomes possible to transmit a file of a still image or a moving image captured by a digital camera to a personal computer on a local network or a server accessible through the Internet (Japanese Patent Laid-Open No. 2013-131085).

The file saved in the server is shared among a plurality of users via a web service such as an SNS (Social Network Service) or a web image album.

With the above-mentioned system, for example, in the case of uploading a file of a still image or a moving image to a web service that is the final saving destination, even if the web service does not support those files, the communication function of the digital camera is activated and thus useless processing is performed.

### SUMMARY OF THE INVENTION

The present invention has been made in consideration of the aforementioned problems, and realizes network connection processing that can prevent occurrence of useless processing by performing control so as not to activate a communication function in the case where a file that can be accepted by a targeted uploading destination does not exist.

In order to solve the aforementioned problems, the present invention provides an image processing apparatus comprising: a connection unit configured to connect to at least one network service; an acquisition unit configured to acquire information regarding the at least one network service that is connectable via the connection unit; a determination unit configured to, in a case where connection to a predetermined network service is instructed by a user, determine whether or not a file that is supported by the predetermined network service is recorded in a recording medium of the image processing apparatus based on the information regarding the predetermined network service acquired by the acquisition unit; and a control unit configured to perform control such that connection to the predetermined network service is not performed in a case where no file that is supported by the predetermined network service is recorded in the recording medium.

In order to solve the aforementioned problems, the present invention provides a system in which an image processing apparatus and an information processing apparatus are connected via a network, wherein the information processing apparatus comprises: a connection unit configured to connect to at least one network service; and a setting unit configured to perform setting for use of the at least one network service by the image processing apparatus, and wherein the image processing apparatus comprises: a connection unit configured to connect to at least one network service; an acquisition unit configured to acquire information regarding the at least one network service that is connectable via the connection unit; a determination unit configured to, in a case where connection to a predetermined network service is instructed by a user, determine whether or not a file that is supported by the network service is recorded in a recording medium of the image processing apparatus based on the information regarding the predetermined network service acquired by the acquisition unit; and a control unit configured to perform control such that connection to the predetermined network service is not performed in a case where no file that is supported by the predetermined network service is recorded in the recoding medium.

In order to solve the aforementioned problems, the present invention provides a control method of an image processing apparatus having a connection unit configured to connect to at least one network service, the method comprising: acquiring information regarding the at least one network service that is connectable via the connection unit; determining, in a case where connection to a predetermined network service is instructed by a user, whether or not a file that is supported by the predetermined network service is recorded in a recoding medium of the image processing apparatus based on the acquired information regarding the predetermined network service; and performing control such that connection to the predetermined network service is not performed in a case where no file that is supported by the predetermined network service is recorded in the recoding medium.

In order to solve the aforementioned problems, the present invention provides a non-transitory computer-readable storage medium storing a program for causing a computer to execute a control method of an image processing apparatus having a connection unit configured to connect to at least one network service, the method comprising: acquiring information regarding the at least one network service that is connectable via the connection unit; determining, in a case where connection to a predetermined network service is instructed by a user, whether or not a file that is supported by the predetermined network service is recorded in a recoding medium of the image processing apparatus based on the acquired information regarding the predetermined network service; and performing control such that connection to the predetermined network service is not performed in a case where no file that is supported by the predetermined network service is recorded in the recoding medium.

According to the present invention, it becomes possible to suppress occurrence of useless processing.

Further features of the present invention will become apparent from the following description of exemplary embodiments (with reference to the attached drawings).

### BRIEF DESCRIPTION OF THE DRAWINGS

FIG. 1 is a diagram showing a system configuration of an embodiment of the present invention.

FIGS. 2A to 2D are block diagrams showing configurations of a digital camera and a smartphone that constitute a system of the embodiment.

FIG. 3 is a diagram showing a communication sequence in the case where a smartphone of the embodiment performs cooperation setting for cooperation with a digital camera in a relay server.

FIGS. 4A to 4D are diagrams illustrating display screens of the digital camera in the case of performing the cooperation setting in FIG. 3.

FIGS. 5A to 5C are diagrams illustrating display screens of the smartphone in the case of performing the cooperation setting in FIG. 3.

FIG. 6 is a diagram showing a communication sequence in the case where the smartphone of the embodiment performs cooperation setting for cooperation between a relay server and a web service server.

FIGS. 7A to 7E are diagrams illustrating display screens of the smartphone in the case of performing the cooperation setting in FIG. 6.

FIG. 8 is a diagram showing a communication sequence in the case where the digital camera of the embodiment acquires web service information from a relay server.

FIG. 9 is a flowchart of processing of acquiring web service information from a relay server, which is performed by the digital camera of the embodiment.

FIGS. 10A and 10B are diagrams illustrating display screens of the digital camera in the case of performing the acquisition of the web service information in FIG. 8.

FIG. 11 is a flowchart showing error display processing when the digital camera of the embodiment is to connect to a web service server via a relay server.

FIGS. 12A and 12B are diagrams illustrating display screens of the digital camera in the case of performing the error display processing in FIG. 11.

### DESCRIPTION OF THE EMBODIMENTS

Embodiments of the present invention will be described in detail below. The following embodiments are merely examples for practicing the present invention. The embodiments should be properly modified or changed depending on various conditions and the structure of an apparatus to which the present invention is applied. The present invention should not be limited to the following embodiments. Also, parts of the embodiments to be described later may be properly combined.

In the present embodiment, a system will be described in which a digital camera serving as an image processing apparatus and a smartphone, which is a type of a mobile phone, serving as an information processing apparatus are connected to a relay server via a network, and the relay server is connected to a web service server via the network. Note that the image processing apparatus of the present invention is not limited to a digital camera, and the present invention can be applied to a tablet device, a smartphone, a music player, a printer or the like. Moreover, the information processing apparatus of the present invention is not limited to a mobile phone, and the present invention can be applied to a mobile electronic device such as a tablet, a personal computer connectable to a wide area network such as the Internet, a television, a printer or the like.

System Configuration

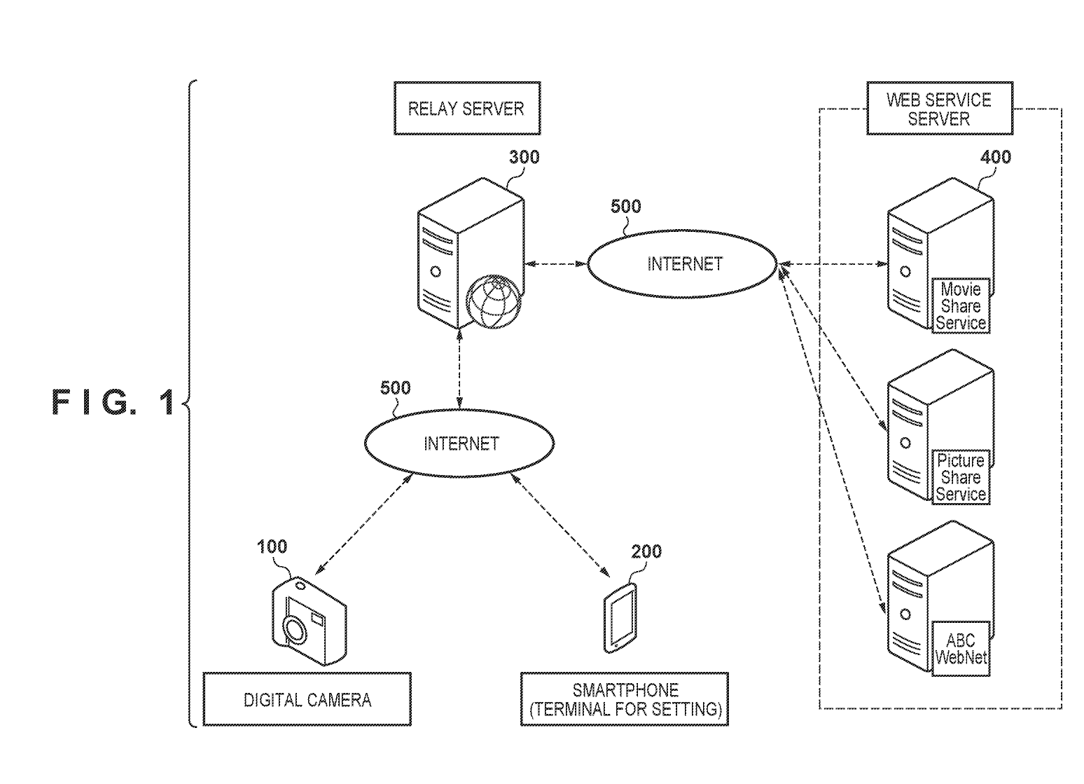

First, the configuration and the functions of the system of the present embodiment will be generally described with reference to FIG. 1.

In FIG. 1, in the system of the present embodiment, a digital camera 100 and a smartphone 200 are connected to a relay server 300 via the Internet 500, and this relay server 300 is connected to a web service server 400 via the Internet 500.

For example, the web service server 400 is a network service site for providing web services for sharing a still image or a moving image of the digital camera 100. The relay server 300 is a relay apparatus that relays communication between the digital camera 100 and the web service server 400. The smartphone 200 functions as a setting terminal for performing, in the relay server 300, cooperation setting for cooperation with the digital camera 100 and setting of a web service provided by the web service server 400.

For example, the digital camera 100 and the smartphone 200 are connected using a wireless communication interface that is in compliance with IEEE802.11x (x is a, b, g, n or the like).

The digital camera 100 and the relay server 300 are connected via the Internet 500, and the smartphone 200 and the relay server 300 are also connected via the Internet 500. Note that devices such as a router and an access point exist as devices that constitute the network via the Internet 500 (not to be described in detail). The web service server 400 is connected to the relay server 300 via the Internet 500. The digital camera 100 and the smartphone 200 perform communication with the web service server 400, which is the communication destination, via the relay server 300.

Note that it is sufficient that the smartphone 200 is a device that has an application such as a web browser for performing setting of the relay server 300.

Configurations of Digital Camera and Smartphone

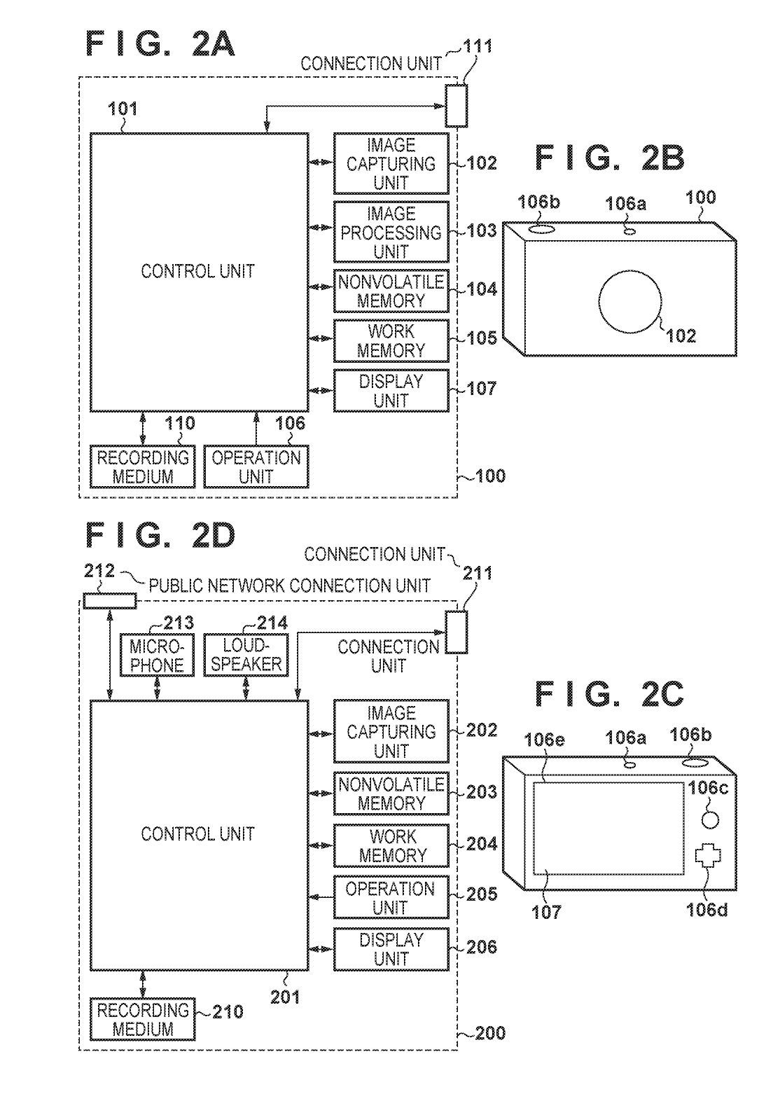

The configuration and functions of a digital camera 100 and a smartphone 200 of the present embodiment will be generally described with reference to FIG. 2.

FIG. 2A is a functional block diagram of a digital camera 100. FIGS. 2B and 2C are front view and back view of the digital camera 100. FIG. 2D is a functional block diagram of a smartphone 200.

First, the configuration and functions of the digital camera 100 will be described with reference to FIGS. 2A to 2C.

Referring to FIG. 2A, a control unit 101 is an arithmetic processing unit (CPU) which comprehensively controls the overall digital camera 100, and implements various types of processes in flowcharts (to be described later) by executing programs stored in a nonvolatile memory 104 (to be described later). Note that a plurality of pieces of hardware may control the overall apparatus by sharing processes instead of making the control unit 101 control the overall apparatus. The control unit 101 herewith functions as an acquisition unit, a determination unit, a control unit, and a storage unit of the present invention.

An image capturing unit 102 includes a lens group including a zoom lens and a focus lens and a shutter having a stop function. The image capturing unit 102 also includes an image sensor formed from a CCD, CMOS device, or the like which converts an object image into an electrical signal, and an A/D converter which converts the analog image signal output from the image sensor into a digital signal.

An image processing unit 103 performs image quality adjustment processing of adjusting white balance, color, brightness, and the like with respect to the image data captured by the image capturing unit 102, and also performs, for example, resize processing to a display size. The image processing unit 103 also generates an image file by compressing and coding the image data having undergone image quality adjustment processing by JPEG or the like, and records the file in a recording medium 110. The image processing unit 103 also performs predetermined arithmetic processing by using captured image data. The control unit 101 then controls the focus lens, stop, and shutter of the image capturing unit 102 based on the obtained arithmetic result, thereby performing AF (Automatic Focus) processing and AE (Automatic Exposure) processing.

The nonvolatile memory 104 is an electrically erasable/recordable memory, and, for example, an EEPROM is used. Constants, programs, and the like for the operation of the control unit 101 are recorded in the nonvolatile memory 104. In this case, the programs are those for executing various types of flowcharts to be described later in this embodiment.

A work memory 105 is used as a work area where constants and variables for the operation of the control unit 101, programs read out from the nonvolatile memory 104, and the like are loaded. The work memory 105 is also used as a buffer memory for temporarily holding the image data captured by the image capturing unit 102 or an image display memory for a display unit 107.

An operation unit 106 is constituted by operation members such as various types of switches and buttons and a touch panel which receive various types of operations from the user, including, for example, a power button 106a for turning on and off a power source, a shutter button 106b for performing a shooting instruction, a mode switching button 106c for switching an operation mode of the camera, and four-directional keys 106d having up, down, left and right buttons for performing various settings of the camera, as shown in FIGS. 2B and 2C. A touch panel 106e integrally formed with a display unit 107 (to be described later) is also included in the operation unit 106. The operation unit 106 herewith functions as a selection unit of the present invention.

The shutter button 106b is turned on to generate a first shutter switch signal SW1 when the shutter button 106b is operated halfway, that is, half-pressed (shooting preparation instruction). Upon receiving the first shutter switch signal SW1, the control unit 101 controls the image capturing unit 102 to start an operation such as AF (Automatic Focus) processing, AE (Automatic Exposure) processing, AWB (Automatic White Balance) processing, or EF (Electronic Flash) processing. In addition, the shutter button 106b is turned on to generate a second shutter switch signal SW2 when the shutter button 106b is operated completely, that is, full-pressed (shooting instruction). Upon receiving the second shutter switch signal SW2, the control unit 101 starts a series of shooting operations from reading out a signal from the image capturing unit 102 to writing image data in the recording medium 110.

The display unit 107 displays a viewfinder image at the time of shooting, a captured image, characters for a dialogical operation, or the like. The display unit 107 is, for example, a display device such as a liquid crystal display or organic EL display. The display unit 107 may be integrally formed with the digital camera 100 or an external apparatus connected to the digital camera 100.

The image processing unit 103 records a coded image file in the recording medium 110. The control unit 101 reads out an already recorded image file from the recording medium 110. The recording medium 110 may be a memory card, hard disk drive, or the like mounted in the digital camera 100, or a flash memory or hard disk drive built in the digital camera 100.

A connection unit 111 is an interface for connection to an external apparatus such as smartphone 200 and relay server 300. The digital camera 100 according to this embodiment can exchange data with an external apparatus via the connection unit 111. Note that in this embodiment, the connection unit 111 includes a wireless LAN communication module for wireless communication with an external apparatus. The control unit 101 implements wireless communication with an external apparatus by controlling the connection unit 111. Note that for example, PTP/IP (Picture Transfer Protocol over internet protocol) through a wireless LAN may be used as a data communication protocol. Note that a communication scheme to be used is not limited to a wireless LAN. For example, USB (Universal Serial Bus) or Bluetooth® can be used. The connection unit 111 may include a wireless communication module such as infrared communication module, Bluetooth® communication module or wireless USB (Universal Serial Bus). Furthermore, a wire connection device such as USB cable, HDMI® or IEEE 1394 may be used.

Next, the configuration and functions of the smartphone 200 will be described with reference to FIG. 2D.

The smartphone 200 according to this embodiment includes a control unit 201, an image capturing unit 202, a nonvolatile memory 203, a work memory 204, an operation unit 205, a display unit 206, a recording medium 210, and a connection unit 211. The basic functions of the respective elements are the same as those of the digital camera 100, and hence a detailed description of them will be omitted.

Note that processing in the smartphone 200 according to this embodiment is implemented by reading software provided by an application. Assume that an application has software for the use of the basic function of the OS installed in the smartphone 200. Note that the OS of the smartphone 200 may have software for implementing processing in this embodiment. The control unit 201 herewith functions as a setting unit of the present invention.

A connection unit 211 includes a wireless LAN communication module for wireless communication with an external apparatus such as a digital camera 100 and a relay server 300. The control unit 201 implements wireless communication with an external apparatus by controlling the connection unit 211. Note that for example, PTP/IP (Picture Transfer Protocol over internet protocol) through a wireless LAN may be used as a data communication protocol. Note that a communication scheme to be used is not limited to a wireless LAN. For example, USB (Universal Serial Bus) or Bluetooth® can be used. The connection unit 211 may include a wireless communication module such as infrared communication module, Bluetooth® communication module or wireless USB (Universal Serial Bus). Furthermore, a wire connection device such as USB cable may be used.

A public network connection unit 212 is an interface used for wireless communication via Wide Area Network (WAN) such as 3G or LTE. The smartphone 200 can perform a telephone call and data communication with another device via the public network connection unit 212. When performing a telephone call, the control unit 201 inputs and outputs voice signals via a microphone 213 and a loudspeaker 214. Assume that in this embodiment, the public network connection unit 212 is not limited to 3G or LTE and it is possible to use another communication scheme such as WiMAX, ADSL or FTTH. In addition, the connection unit 211 and the public network connection unit 212 need not be implemented by independent pieces of hardware. For example, one antenna can have both the functions.

Communication Sequence for Cooperation Setting for Cooperation with Digital Camera and Relay Server

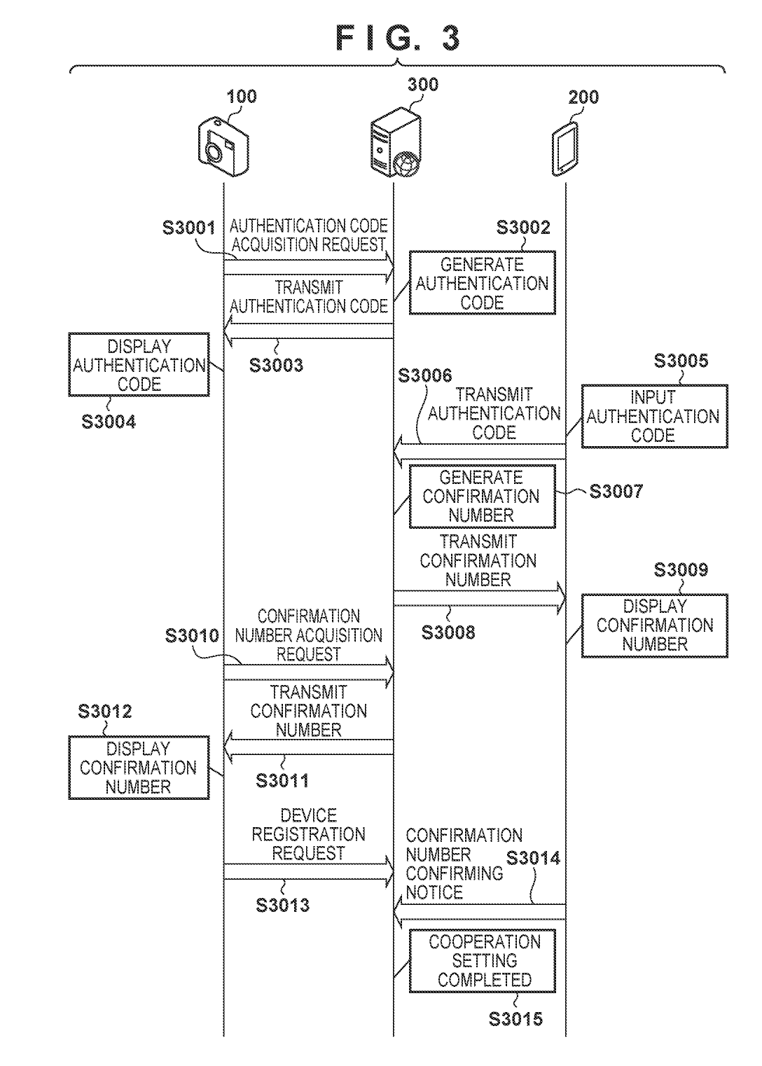

Next, a communication sequence in the case where the smartphone 200 of the present embodiment performs cooperation setting for cooperation with the digital camera 100 and the relay server 300 will be described with reference to FIGS. 3 to 5C.

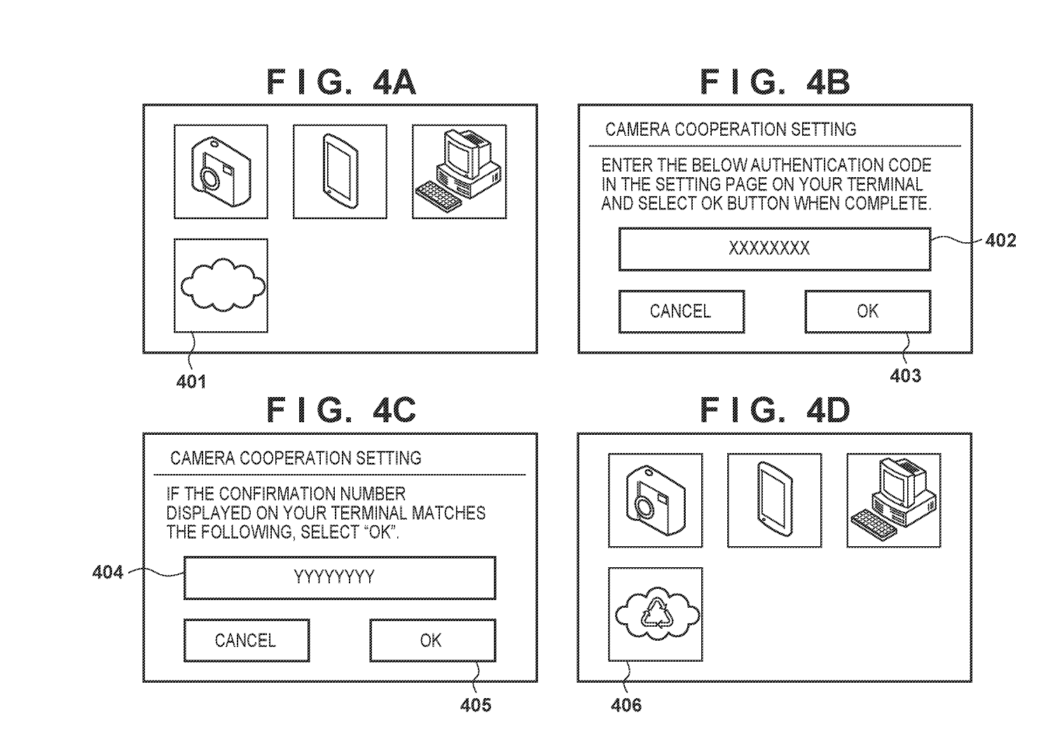

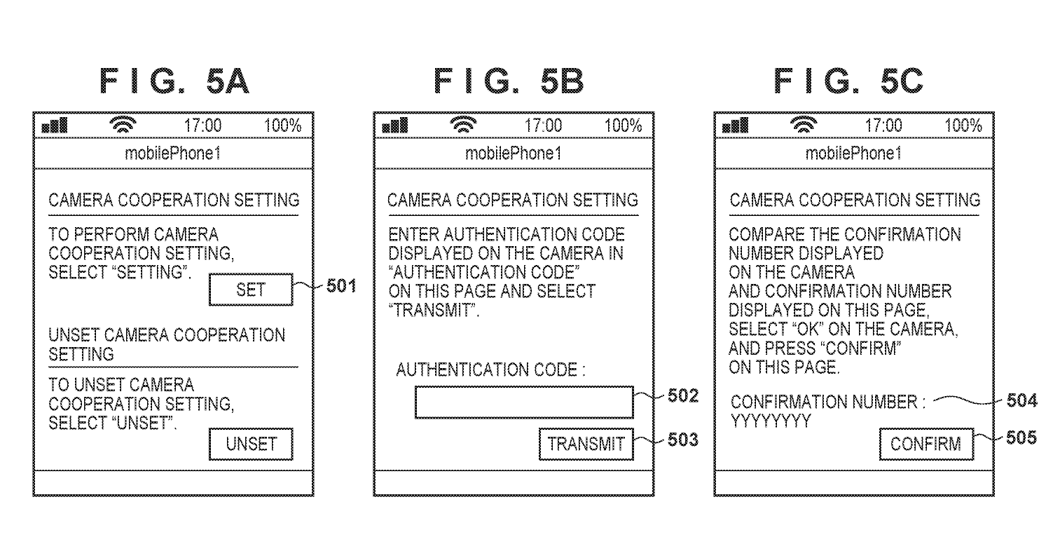

FIG. 3 shows a communication sequence in the case where the smartphone 200 of the present embodiment performs cooperation setting for cooperation with the digital camera 100 in the relay server 300. FIGS. 4A to 4D and 5A to 5C respectively illustrate display screens of the digital camera 100 and the smartphone 200 in the case of performing the cooperation setting of FIG. 3.

The communication sequence of the present embodiment is started by a user using the operation unit 106 of the digital camera 100 to select an icon 401 for connecting to the relay server 300 and starting cooperation setting in the screen in FIG. 4A for selecting a wireless LAN connection partner.

When the processing is started, the digital camera 100 issues an authentication code acquisition request to the relay server 300 in step S3001. Upon receiving the authentication code acquisition request from the digital camera 100, the relay server 300 performs generation of an authentication code in step S3002, and transmits the authentication code to the digital camera 100 in step S3003. Upon receiving the authentication code from the relay server 300, the digital camera 100 displays the authentication code like a text display 402 in the screen in FIG. 4B, and prompts the user to enter the authentication code on the smartphone 200, in step S3004.

Next, when the user selects a camera cooperation setting start button 501 on the screen in FIG. 5A via the operation unit 205 of the smartphone 200, a screen for entering an authentication code in an authentication code input text box 502 is displayed as in FIG. 5B.

In step S3005, when the user enters the authentication code in the authentication code input text box 502 on the screen in FIG. 5B via the operation unit 205 and selects a transmit button 503, the smartphone 200 transmits the input authentication code to the relay server 300 in step S3006.

Upon receiving the authentication code from the smartphone 200, the relay server 300 compares the authentication code with the authentication code generated in step S3002. If they match, a confirmation number is generated in step S3007, and the confirmation number is transmitted to the smartphone 200 in step S3008. Upon receiving the confirmation number, the smartphone 200 displays, in step S3009, the received confirmation number in a text display portion 504 on the screen in FIG. 5C.

When the user selects an OK button 403 on the screen in FIG. 4B via the operation unit 106 of the digital camera 100, a confirmation number acquisition request is transmitted to the relay server 300 in step S3010. Upon receiving the confirmation number acquisition request from the digital camera 100, the relay server 300 transmits the confirmation number generated in step S3007 to the digital camera 100 in step S3011. Upon receiving the confirmation number from the relay server 300, the digital camera 100 displays, in step S3012, the confirmation number in a text display portion 404 on the screen in FIG. 4C. When the user selects an OK button 405 on the screen in FIG. 4C via the operation unit 106 of the digital camera 100, the digital camera 100 issues a device registration request to the server 300 in step S3013. In addition, when the user selects a confirmation button 505 on the screen in FIG. 5C via the operation unit 205, the smartphone 200 issues a confirmation number confirming notice to the relay server 300 in step S3014. Due to the relay server 300 receiving both the device registration request from the digital camera 100 and the confirmation number confirming notice from the smartphone 200, the cooperation setting is considered to have been completed in step S3015.

When the cooperation setting is completed, the digital camera 100 displays an icon 406 for acquiring web service information from the relay server 300 such as that on the screen in FIG. 4D, and the cooperation setting for cooperation with the digital camera 100 in the relay server 300 is completed.

Communication Sequence for Cooperation Setting for Cooperation between Relay Server and Web Service Server

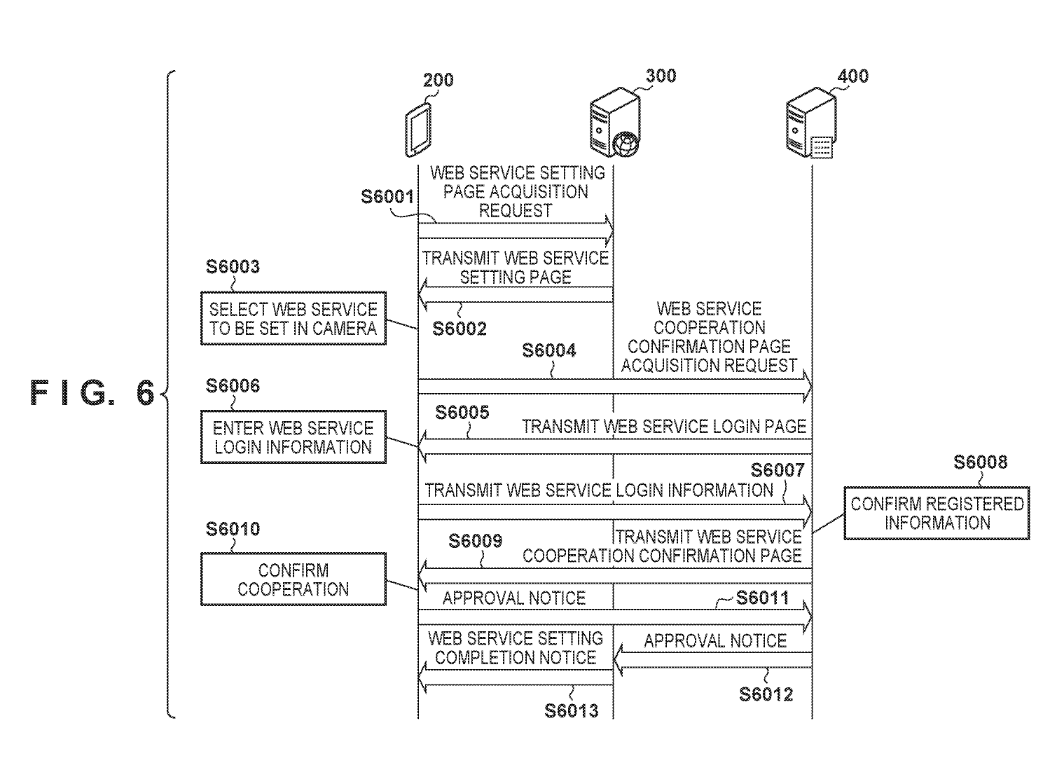

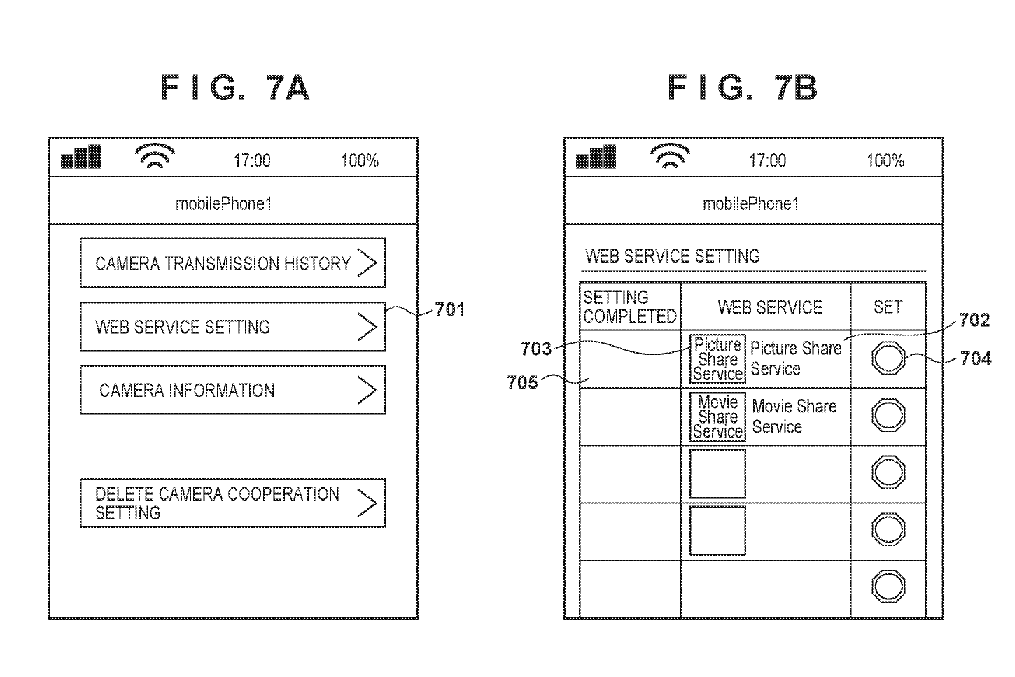

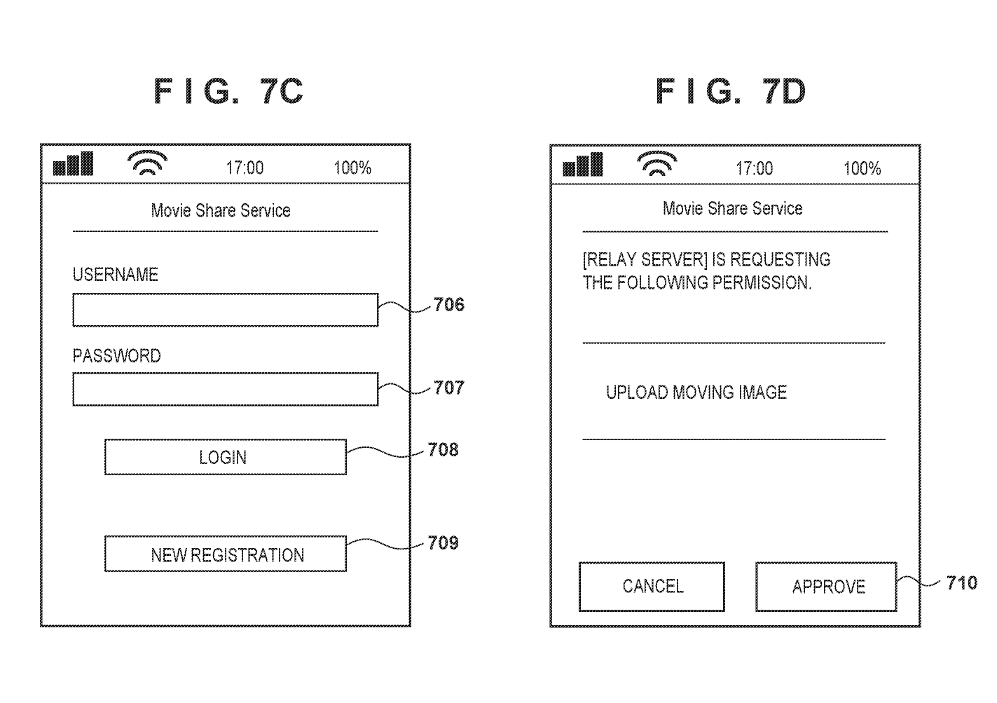

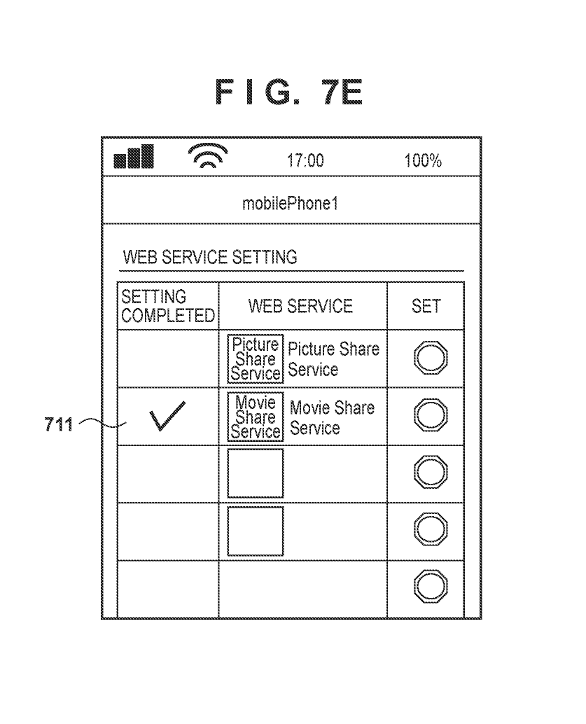

Next, a communication sequence in the case where the smartphone 200 of the present embodiment performs cooperation setting for cooperation between the relay server 300 and the web service server 400 will be described with reference to FIGS. 6 and 7A to 7E.

FIGS. 7A to 7E illustrate display screens of the smartphone 200 in the case of performing the cooperation setting in FIG. 6.

The communication sequence of the present embodiment is started by a user using the operation unit 205 of the smartphone 200 to select a button 701, for connecting to the relay server 300 and starting web service setting, on the screen in FIG. 7A for the smartphone 200 to perform setting regarding the digital camera 100 in the web service server 400.

When the processing is started, the smartphone 200 issues a web service setting page acquisition request to the relay server 300 in step S6001. Upon receiving the web service setting page acquisition request from the smartphone 200, the relay server 300 transmits a web service setting page to the smartphone 200 in step S6002. In this case, on the smartphone 200, a web service list such as that on the screen in FIG. 7B is displayed, for example. On the screen in FIG. 7B, a list of web services with which the relay server 300 can cooperate is displayed, and a name 702, an icon 703, a link 704 to a cooperation confirmation page, and a setting complete item 705 are prepared for each of the web services. In the screen in FIG. 7B, cooperation setting has not been performed yet for cooperation with any of the web services, and thus the setting complete items 705 are all blank.

When the user selects, via the operation unit 205, the link 704 to the cooperation confirmation page of the web service for which the user wishes to perform cooperation setting in step S6003, the smartphone 200 issues a web service cooperation confirmation page acquisition request to the web service server 400 in step S6004. Upon receiving the web service cooperation confirmation page acquisition request from the smartphone 200, the web service server 400 transmits a web service login page to the smartphone 200 in step S6005. Here, the web service login page transmitted from the web service server 400 to the smartphone 200 is displayed on the smartphone 200 as in FIG. 7C, for example. In step S6006, the user enters information corresponding to the web service in a username input text box 706 and a password input text box 707 on the screen in FIG. 7C using the operation unit 205, and selects a login button 708 so as to log in to the web service of the web service server 400. Here, besides using the information that was registered in advance regarding a username and a password, a new registration button 709 may be selected to issue a new username and password.

Upon receiving the web service login information from the smartphone 200, the web service server 400 compares the login information with registered information in step S6008. In the case where the username and password match the registered information as a result of the comparison, the web service server 400 transmits the web service cooperation confirmation page to the smartphone 200 in step S6009. Upon receiving the web service cooperation confirmation page from the web service server 400, the smartphone 200 displays a screen for confirming the web service cooperation result between the relay server 300 and the web service server 400 as in FIG. 7D.

When the user selects an approval button 710 on the screen in FIG. 7D using the operation unit 205 of the smartphone 200 in step S6010, the smartphone 200 issues an approval notice to the web service server 400 in step S6011. Upon receiving the approval notice from the smartphone 200, the web service server 400 issues an approval notice to the relay server 300 in step S6012. Upon receiving the approval notice from the web service server 400, the relay server 300 issues a web service setting completion notice to the smartphone 200 in step S6013. Upon receiving the web service setting completion notice from the relay server 300, the smartphone 200 displays, on the screen in FIG. 7E, a page in which a setting completion item 711 is checked for the web service for which web service setting has been completed.

By executing the above procedures, the web service cooperation setting between the relay server 300 and the web service server 400 is completed.

Acquisition of Web Service Information from Relay Server

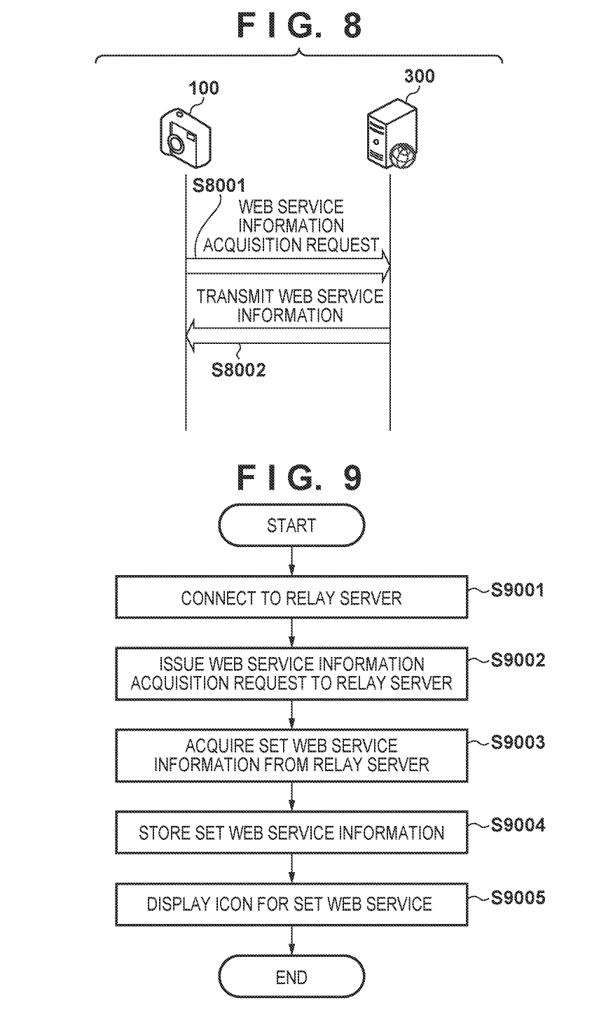

Next, a communication sequence in the case where the digital camera 100 of the present embodiment acquires web service information from the relay server 300 will be described with reference to FIGS. 8 to 10B.

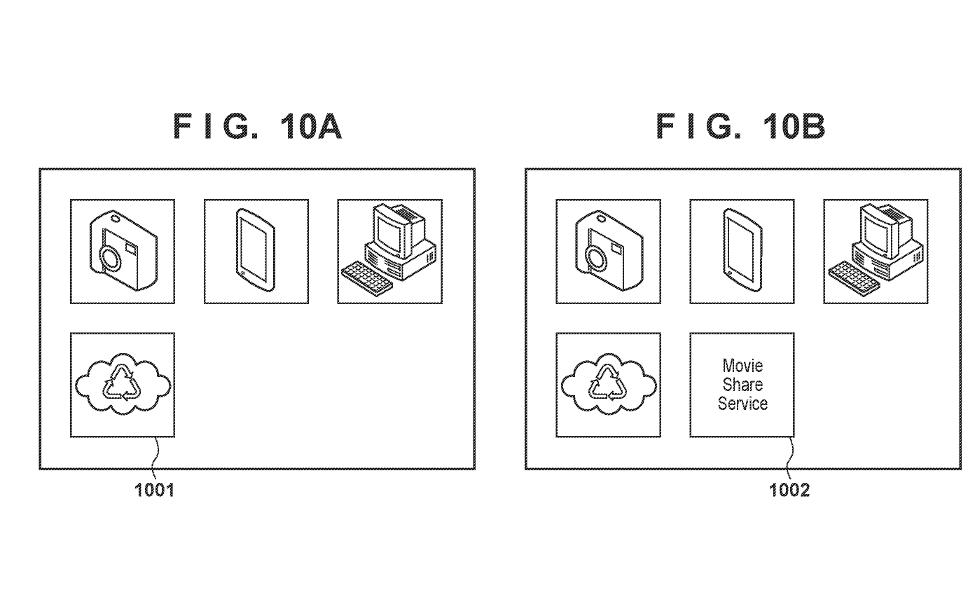

FIG. 9 shows processing in which the digital camera 100 of the present embodiment acquires web service information from the relay server 300. FIGS. 10A and 10B illustrate display screens of the digital camera 100 in the case of performing the acquisition of web service information in FIG. 8.

This communication sequence of the present embodiment is started by a user selecting, on the screen in FIG. 10A for the digital camera 100 to acquire web service information from the relay server 300, an icon 1001 via the operation unit 106 of the digital camera 100.

When the processing is started, the digital camera 100 issues a web service information acquisition request to the relay server 300 in step S8001. Upon receiving the web service information acquisition request from the digital camera 100, the relay server 300 transmits, in step S8002, web service information regarding web services for which cooperation setting have been made. Here, the web service information transmitted from the relay server 300 includes an icon indicating the web service, and file information regarding files supported by the web service. The file information includes, for example, file information indicating a file type such as a still image or a moving image, file information indicating a file size such as a resolution or the number of pixels in the case of a still image or a recording time in the case of a moving image, and information regarding the content of a still image or a moving image (e.g., presence or absence of a person as an object). Moreover, even with the same web service, the web service information to be transmitted may be different depending on whether the user is a user who is allowed to use only limited services, or a user who is allowed to use all the services, for example.

Upon receiving the web service information transmission from the relay server 300, the digital camera 100 stores the web service information, and displays, on the screen in FIG. 10B, an icon 1002 for connection with the web service server 400.

Processing in which the digital camera 100 of the present embodiment acquires connection destination web service information from the relay server 300 will be described below with reference to FIGS. 9 and 10A and 10B.

Note that the processing in FIG. 9 is realized by the control unit 101 of the digital camera 100 loading, into the work memory 105, a communication sequence program read out from the nonvolatile memory 104 and executing the program.

In step S9001, the control unit 101 establishes a connection with the relay server 300 using the connection unit 111.

In step S9002, the control unit 101 issues a web service information acquisition request to the relay server 300 using the connection unit 111.

In step S9003, the control unit 101 acquires web service information from the relay server 300 using the connection unit 111.

In step S9004, the control unit 101 stores the web service information acquired from the relay server 300 to the nonvolatile memory 104.

In step S9005, the control unit 101 displays, on the display unit 107, the screen in FIG. 10B in which the icon 1002 indicating connection with the web service, for which the setting has been made, is displayed.

With the above processing, processing in which the digital camera 100 acquires web service information regarding a web service, for which the setting has been made, from the relay server 300 is completed.

Error Display Processing at Time of Connection to Web Service Server

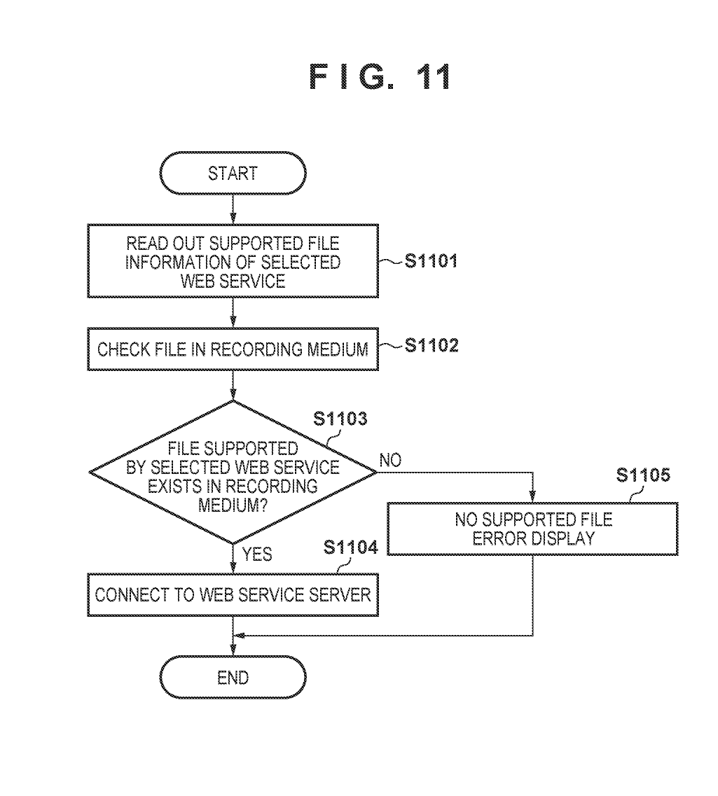

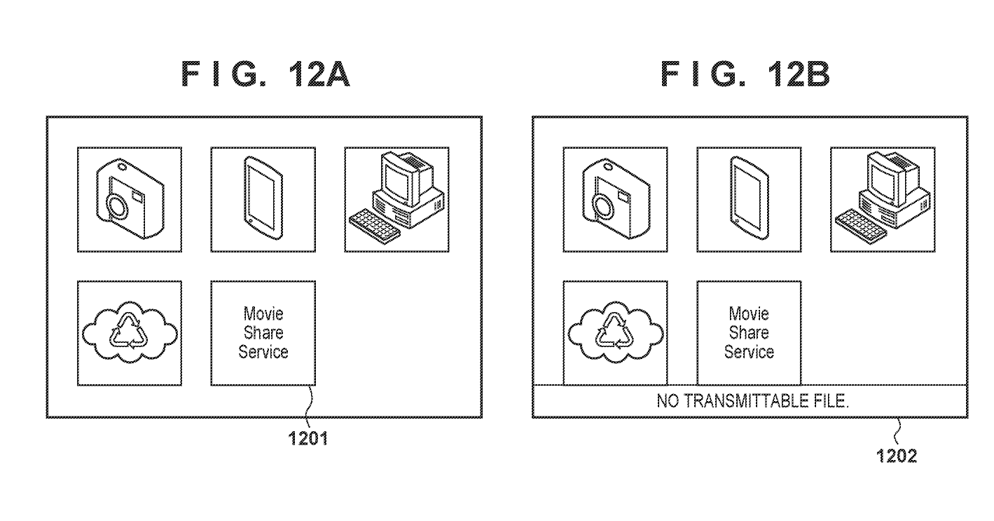

Next, the error display processing when the digital camera 100 of the present embodiment is to connect to the web service server 400 via the relay server 300 will be described with reference to FIGS. 11 and 12A and 12B.

FIGS. 12A and 12B illustrate display screens of the digital camera 100 in the case of performing the error display in FIG. 11.

Note that the processing in FIG. 11 is realized by the control unit 101 of the digital camera 100 loading, in the work memory 105, a communication sequence program read out from the nonvolatile memory 104 and executing the program.

The processing is started by a user selecting, on the screen in FIG. 12A, an icon 1201 for the connection with the web service server 400 via the operation unit 106 of the digital camera 100.

In step S1101, the control unit 101 reads out, from the nonvolatile memory 104 that stored the web service information in the above-mentioned step S9004, supported file information that corresponds to the web service selected using the icon 1201 on the screen in FIG. 12A. Here, the supported file information includes information indicating whether the files that can be uploaded to the selected web service are “only still images”, “only moving images”, or “still images and moving images”.

In step S1102, the control unit 101 checks whether or not at least one out of a still image and a moving image exists in the recording medium 110.

In step S1103, the control unit 101 determines whether or not a file that is supported by the selected web service exists in the recording medium 110. As a result of the determination, in the case where a file that is supported by the selected web service exists, the procedure advances to step S1104, and in the case where such a file does not exist, the procedure advances to step S1105.

In step S1104, the control unit 101 connects to the web service server 400 via the relay server 300 using the connection unit 111.

In step S1105, the control unit 101 displays, on the screen in FIG. 12B, a message 1202 indicating that a file that can be transmitted to the web service does not exist, for example.

According to the above processing, when the digital camera 100 is to connect to the web service server 400 via the relay server 300, in the case where a file that can be transmitted to the web service does not exist in the recording medium 110, and connection to the web service server 400 would be useless, it is possible to perform control such that error display is immediately performed and the communication function is not activated. Thereby, in the state where the digital camera 100 does not have a file that is supported by a targeted web service, even in the case where access to the web service is requested by a user, useless communication connection processing can be omitted.

Note that in the present embodiment, a file that can be uploaded is determined depending on whether the file is a still image or a moving image, but the present invention is not necessarily limited thereto. For example, even with still images, there are web services to which JPEG images can be transmitted but so-called RAW images cannot be transmitted, or the like. In this case, the presence or absence of a JPEG image is checked in step S1102. In addition, even with moving images, there are web services to which MPEG moving images can be transmitted but AVCHD moving images cannot be transmitted, or the like. In this case, the presence or absence of an MPEG moving image is checked in step S1102.

In addition, a configuration may be adopted in which in the case of performing selection of a web service shown in FIGS. 12A and 12B before connection with a network (e.g., before connection with a wireless LAN access point), connection with the wireless LAN access point is not performed. Such a configuration not only makes it possible to prevent connection with a web service server, which would be consequently useless, but also makes it possible to prevent useless connection with the wireless LAN access point.

Moreover, in the present embodiment, a web service was described as an example, but the present invention can be applied to the case in which a printer server, a media player, a storage apparatus or the like is the transmission destination via a network, for example.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-251074, filed Dec. 11, 2014 which is hereby incorporated by reference herein in its entirety.

What is claimed is:

1. An image processing apparatus comprising:
a connection unit configured to connect to at least one network service;
an acquisition unit configured to acquire information regarding the at least one network service that is connectable via the connection unit;
a determination unit configured to, in a case where connection to a predetermined network service is instructed by a user, determine whether or not a file that is supported by the predetermined network service is recorded in a recording medium of the image processing apparatus based on the information regarding the predetermined network service acquired by the acquisition unit; and
a control unit configured to perform control such that connection to the predetermined network service is not performed in a case where no file that is supported by the predetermined network service is recorded in the recording medium.

2. The apparatus according to claim 1, further comprising:
a notification unit configured to give notice of not performing connection to the predetermined network service because no file that is supported by the predetermined network service is recorded in the recording medium.

3. The apparatus according to claim 1, further comprising:
a storage unit configured to store the information regarding at least one network service acquired by the acquisition unit;
a display unit configured to display at least one network service corresponding to the information stored in the storage unit; and
a selection unit configured to select a predetermined network service from among the displayed network services.

4. The apparatus according to claim 1,
wherein the connection unit is connectable to the at least one network service via a relay apparatus, and
setting for use of the at least one network service by the image processing apparatus is performed by an information processing apparatus that is connectable to the relay apparatus.

5. The apparatus according to claim 4,
wherein the relay apparatus stores information regarding the at least one network service for which the setting has been made.

6. The apparatus according to claim 1,
wherein the information regarding at least one network service includes information indicating a file type of at least one of a moving image and a still image.

7. The apparatus according to claim 1,
wherein file information regarding at least one network service includes information indicating a file size of at least one of a moving image and a still image.

8. The apparatus according to claim 1,
wherein the information includes information regarding at least one network service indicating an object in at least one of a moving image and a still image.

9. The apparatus according to claim 1, further comprising:
an image capturing unit configured to capture an image.

10. A system in which an image processing apparatus and an information processing apparatus are connected via a network,
wherein the information processing apparatus comprises:
a connection unit configured to connect to at least one network service; and
a setting unit configured to perform setting for use of the at least one network service by the image processing apparatus, and
wherein the image processing apparatus comprises:
a connection unit configured to connect to at least one network service;
an acquisition unit configured to acquire information regarding the at least one network service that is connectable via the connection unit;
a determination unit configured to, in a case where connection to a predetermined network service is instructed by a user, determine whether or not a file that is supported by the network service is recorded in a recording medium of the image processing apparatus based on the information regarding the predetermined network service acquired by the acquisition unit; and
a control unit configured to perform control such that connection to the predetermined network service is not performed in a case where no file that is supported by the predetermined network service is recorded in the recoding medium.

11. A control method of an image processing apparatus having a connection unit configured to connect to at least one network service, the method comprising:
acquiring information regarding the at least one network service that is connectable via the connection unit;
determining, in a case where connection to a predetermined network service is instructed by a user, whether or not a file that is supported by the predetermined network service is recorded in a recoding medium of the image processing apparatus based on the acquired information regarding the predetermined network service; and
performing control such that connection to the predetermined network service is not performed in a case where no file that is supported by the predetermined network service is recorded in the recoding medium.

12. A non-transitory computer-readable storage medium storing a program for causing a computer to execute a control method of an image processing apparatus having a connection unit configured to connect to at least one network service, the method comprising:
acquiring information regarding the at least one network service that is connectable via the connection unit;
determining, in a case where connection to a predetermined network service is instructed by a user, whether or not a file that is supported by the predetermined network service is recorded in a recording medium of the image processing apparatus based on the acquired information regarding the predetermined network service; and
performing control such that connection to the predetermined network service is not performed in a case where no file that is supported by the predetermined network service is recorded in the recoding medium.
